(19) United States
(12) Patent Application Publication
(10) Pub. No.: US 2025/0211952 A1
(43) Pub. Date: Jun. 26, 2025

(54) OUT OF ORDER EVENT DETECTION

(71) Applicant: X DEVELOPMENT LLC, Mountain View, CA (US)

(72) Inventors: Sajeev Saluja, Cupertino, CA (US); Patrick Briggs, Austin, TX (US); Bin He, Los Altos, CA (US); Joana Pascoal, Superior, CO (US); Xuejing Jiao, Austin, TX (US)

(73) Assignee: X DEVELOPMENT LLC, Mountain View, CA (US)

(21) Appl. No.: 18/888,740

(22) Filed: Sep. 18, 2024

Related U.S. Application Data
(60) Provisional application No. 63/613,469, filed on Dec. 21, 2023.

(51) Int. Cl. H04W 4/38; H04W 4/029

(52) U.S. Cl. CPC H04W 4/38; H04W 4/029

(57) ABSTRACT

Aspects of the disclosure provide a method for out of order event detection for tracked objects. For example, payload that includes one or more values for a tracked object and a timestamp may be received. That the payload is received out of order may be determined based on the timestamp. The one or more value of the payload may be compared to one or more conditions. Based on the comparison and the determination that the payload was received out of order, that an event associated with the one or more conditions has occurred may be determined. When the event is determined to have occurred, an alert may be generated which identifies the tracked object as well as time information identifying when the one or more conditions were met.

### CROSS REFERENCE TO RELATED APPLICATIONS

This application claims the benefit of the filing date of U.S. Provisional Application No. 63/613,469, filed Dec. 21, 2023, the entire disclosure of which is incorporated by reference herein.

### BACKGROUND

The Internet of Things (IoT) is the inter-networking of physical objects, such as products, packages, vehicles, buildings, etc., that are embedded with electronic components for network connectivity. The embedded components enable objects to detect others, be detected by others, collect data and/or transmit data. In some examples, the embedded components may include tags or labels attached to the physical objects. These tags or labels may be passive or active. The inter-networking capabilities may be leveraged for tracking locations of physical objects. In many situations, objects may be moved at different points in time, such as a package or equipment moved from a truck to a loading dock to a warehouse, or medical equipment that is moved between different rooms (or floors) in a hospital. These types of situations can be very challenging to determine the location of the object with suitable accuracy, including updating of the location as that location changes. In addition, systems that use GPS or Wi-Fi may suffer from signal dropout or transmitters going offline, which can reduce the ability to properly identify an object's location.

### BRIEF SUMMARY

Aspects of the disclosure provide a method. The method includes receiving, by one or more processors, a payload that includes one or more values for a tracked object and a timestamp; determining, by the one or more processors, that the payload is received out of order based on the timestamp; comparing, by the one or more processors, the one or more value of the payload to one or more conditions; based on the comparison and the determination that the payload was received out of order, determining, by the one or more processors, that an event associated with the one or more conditions has occurred; and when the event is determined to have occurred, generating, by the one or more processors, an alert identifying the tracked object as well as a timestamp identifying when the one or more conditions were met.

In one example, the method also includes updating an entry in a table of conditions based on the comparison and the determination that the payload was received out of order. In this example, updating the entry includes changing the timestamp of the entry to the timestamp of the payload. In another example, the method also includes adding a new entry in a table of conditions based on the comparison and the determination that the payload was received out of order. In another example, the method also includes receiving a second payload with a second value for the tracked object and a second timestamp and, in response to the second payload, generating a second alert that indicates that the second value of the second payload has canceled the alert. In this example, the method also includes updating an entry in a table of conditions based on the second timestamp of the second payload. In addition, updating the entry includes changing the timestamp of the entry to the timestamp of the payload. In another example, the one or more values includes a sensed characteristic of the tracked object. In this example, the sensed characteristic includes temperature.

Another aspect of the disclosure provides a system comprising one or more processors. The one or more processors are configured to receive a payload that includes one or more values for a tracked object and a timestamp; determine that the payload is received out of order based on the timestamp; compare the one or more value of the payload to one or more conditions; based on the comparison and the determination that the payload was received out of order, determine that an event associated with the one or more conditions has occurred; and when the event is determined to have occurred, generate an alert identifying the tracked object as well as a timestamp identifying when the one or more conditions were met.

In one example, the one or more processors are further configured to update an entry in a table of conditions based on the comparison and the determination that the payload was received out of order. In this example, the one or more processors are further configured to update the entry by changing the timestamp of the entry to the timestamp of the payload. In another example, the one or more processors are further configured to add a new entry in a table of conditions based on the comparison and the determination that the payload was received out of order. In another example, the one or more processors are further configured to: receive a second payload with a second value for the tracked object and a second timestamp; and, in response to the second payload, generate a second alert that indicates that the second value of the second payload has canceled the alert. In this example, the one or more processors are further configured to update an entry in a table of conditions based on the second timestamp of the second payload. In addition, the one or more processors are further configured to update the entry by changing the timestamp of the entry to the timestamp of the payload. In another example, the one or more values includes a sensed characteristic of the tracked object. In addition, the sensed characteristic includes temperature. In another example, the system also includes a reader device, wherein the payload is received from the reader device. In another example, the system also includes the tracked object.

### BRIEF DESCRIPTION OF THE DRAWINGS

FIG. 1A illustrates various examples for localization of objects in accordance with aspects of the technology.

FIG. 1B is a functional diagram of an example tracking system in accordance with aspects of the disclosure.

FIG. 2 is a pictorial diagram of an example network in accordance with aspects of the disclosure.

FIG. 3 is a functional diagram of the example network in FIG. 2 in accordance with aspects of the disclosure.

FIGS. 4A-B illustrate example scenarios in accordance with aspects of the disclosure.

FIG. 4B illustrates another example of a system having a number of fixed tracking tags positioned along different aisles in a warehouse setting.

FIG. 5 is an example functional diagram of a tracking tag, reader devices, and server computing devices in accordance with aspects of the disclosure.

FIG. 6 depicts an example functional diagram of software modules in server computing devices in accordance with aspects of the disclosure.

FIG. 7 depicts example conditions in accordance with aspects of the disclosure.

FIG. 8 is an example flow diagram in accordance with aspects of the disclosure.

FIGS. 9-21 are example timelines for conditions and various situations in accordance with aspects of the disclosure.

### DETAILED DESCRIPTION

### Overview

The technology relates to a system for tracking objects and monitoring conditions of the tracked objects that can handle out of order event detection. The system may generate events for events corresponding to the monitored conditions of the tracked objects. For instance, a tracking device attached to the tracked object, the tracked object, and/or an intermediary reader device may send one or more signals including a payload to one or more server computing devices. A payload may include a data packet generated by a tracking device for tracking an object. Each payload contains at least one item of data (typically produced by a sensor of the tracking device) and a timestamp. These payloads may take various forms and may be stored as reports by the server computing devices in a storage system for later retrieval and use as needed. The server computing devices may run periodic queries on a database where conditions of the tracked objects are recorded. Based on results of the periodic queries, the server computing devices may determine that one or more events has occurred and generate one or more corresponding events. For events that rely on multiple conditions existing, the queries may be quite complex and may collectively consume considerable compute power.

Sometimes, payloads may be received out of order. For instance, the system may include different types of the aforementioned reader devices. As an example, one type of reader device may be connected to power (e.g., line powered) and another type of reader device may run on battery power or other internal power source. Because battery powered reader devices may send signals periodically and line powered reader devices may send signals continuously, at least some signals (and respective payloads) may be received by the server computing devices out of order.

To reduce the likelihood of false events and more efficiently process out of order payloads, the server computing devices may implement various software modules and tables as discussed further below.

### Example Systems

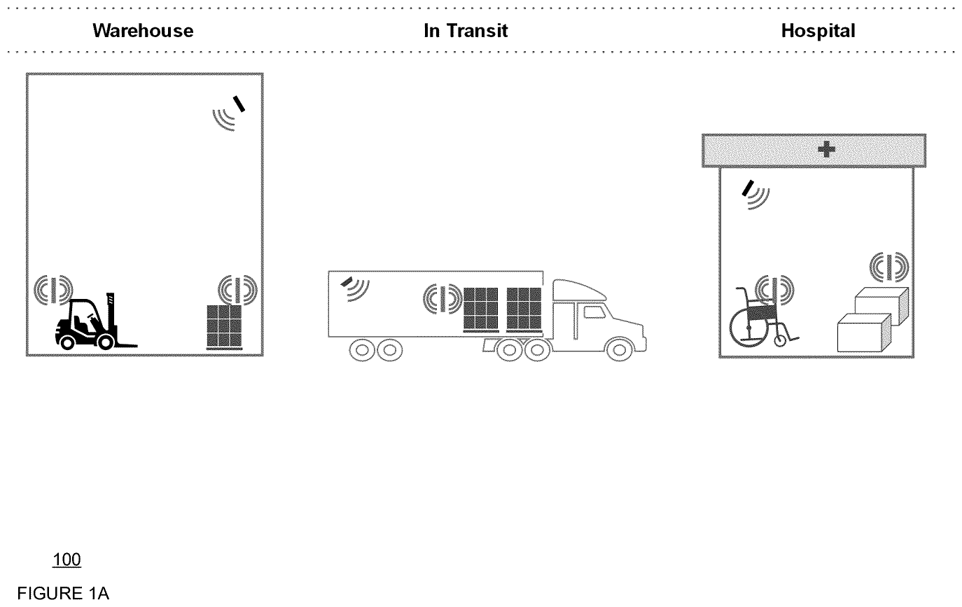

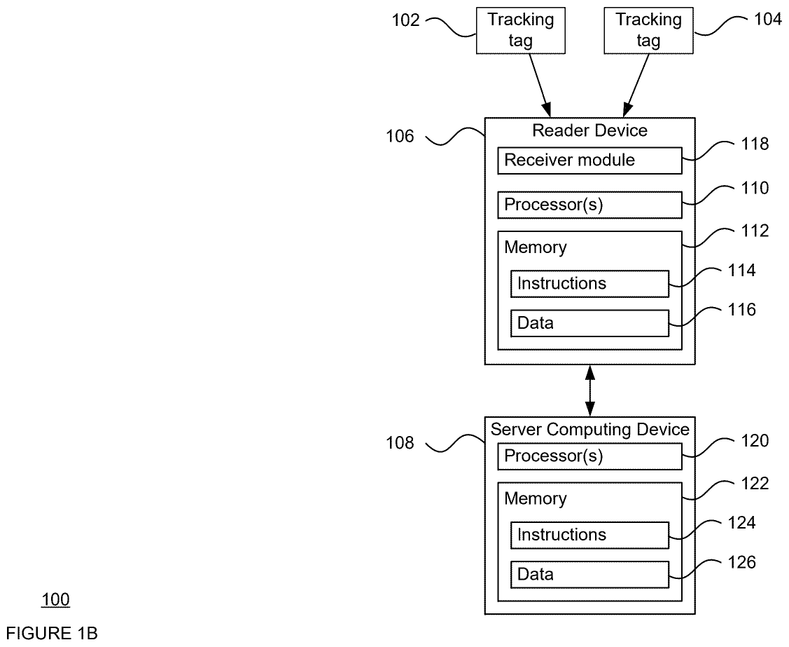

FIG. 1A illustrates examples of different objects in various environments. As shown on the left side image of the figure, there may be packages or equipment on a pallet in a warehouse. The pallet may have come off of a cargo truck as shown by the “In Transit” image in the middle of the figure. The pallet may be moved to one or more different locations within a warehouse, such as by the forklift shown in the left side image. The right-side image in the figure illustrates a situation where medical equipment (e.g., a wheelchair) and supplies in boxes may be stored in a supply room in a hospital.

In all of these situations—in the warehouse, on the cargo truck, or at the hospital, the objects of interest may move around. That may be to a different aisle or room in the warehouse, a different room (or even a different floor) of the hospital, or different part of the cargo container of the truck. In the latter case, the cargo may have shifted during transit or may have been repositioned as different packages were delivered to different locations. Knowing where the objects of interest are currently located, as opposed to where they are presumed to be based on an initial placement, is a valuable piece of information for an office manager, warehouse manager, nurse or orderly to have. Ideally, such people should be able to get the current location of a given object on their client computing device such as a laptop, mobile phone or smartwatch.

FIG. 1B is a functional diagram of a tracking system 100. The tracking system 100 may include a plurality of tracking devices, such as tracking tags 102 and 104, and a reader device 106. As discussed further below, one or more server computing devices 108 may also be part of the tracking system 100. A given tracking tag may be placed on or otherwise attached to or inserted into an object to be tracked, such as a package, a piece of equipment, a vehicle, a warehouse section, a room, etc. While tracking tags 102 may be associated with objects such as packages, equipment or vehicles (e.g., a forklift or an autonomous fulfillment robot that can retrieve packages from different locations in a warehouse), tracking tags 104 may be fixed to an aisle in a warehouse or from a specific room in a hospital. Thus, different tracking tags may be used depending upon user needs. As an example, different users may have varying accuracy and “liveliness” needs. For instance, one user may only want to know aisle-level accuracy every day (e.g., before a warehouse closes for the evening), while another user such as a hospital nurse may need to know which room a piece of equipment is in every hour so that it can be accessed should a patient need such equipment. Each tracking tag 102 or 104 may emit an informational signal, for example a beacon signal, via an antenna, such as using the transmitting device, to communicate data. In this regard, each tracking tag may include an identifier chip (such as for radiofrequency (RF) identification) and/or a transmitting device (such as an RF module configured to transmit beacon signals using a selected frequency band and transmission protocol). In this regard, the beacon signals may simply transmit identifying information in order to enable tracking of objects in the case of tracking tags discussed further below. To facilitate this, each tracking tag may be embedded with a unique identifier, such as a unique MAC address or BLUETOOTH identifier, which may function as a tracking tag identifier. This tracking tag identifier may be assigned to the tracking tag during the manufacturing or provisioning processes (described further below).

The transmitting device may send such information via radio frequency transmission in a selected frequency band, using a standard or proprietary protocol. By way of example, the transmitting device may employ a BLUETOOTH (e.g., a BLUETOOTH Low Energy (BLE)) or 802.11 protocol in the 2.4 GHz and/or 5 GHz frequency bands. In some examples, each beacon tracking tag and each tracking tag uses the BLUETOOTH or BLE protocol.

In some instances, the tracking tags may include one or more sensors. In such instances, the aforementioned communicated data may be formatted according to the selected protocol and include one or more sensed characteristics of the given tracking tag or its environment. For example, the sensed characteristic may be a temperature, motion, light, pressure, location, object details, battery conditions, trip conditions, signal strength and/or other detectable characteristics of the tracking device tracked object or their environment

The reader device 106 may be a computing device configured to detect the beacon signals emitted by the plurality of tracking tags 102 and 104, then store and/or transmit data related to the tracking tags. While only one reader is shown in FIG. 1B, the system may employ multiple readers. The reader device 106 may include one or more processors 110, memory 112 and other components typically present in general purpose computing devices. The reader device 106 includes a receive module 118 having an antenna and a processing section (not shown), which may include a bandpass filter for the frequency band of interest, an analog to digital (A/D) converter, and a signal processing module to evaluate information in received beacon signals. The processing section may also convert the received beacon signal to a baseband signal, before or after A/D conversion. As an example, the reader device may be a fixed device (e.g., mounted on a wall or ceiling and line powered) or may be a mobile device (e.g., a mobile phone, tablet, hand-held scanner, or other device).

The one or more processors 110 may be any conventional processors, such as commercially available CPUs or microcontrollers. Alternatively, the one or more processors may be a dedicated device such as an ASIC or other hardware-based processor, such as a field programmable gate array (FPGA). Although FIG. 1B functionally illustrates the processor(s), memory, and other elements of the reader device 106 as being within the same block, the processor, computing device, or memory may actually include multiple processors, computing devices, or memories that may or may not be stored within the same physical housing. For example, memory may be a hard drive, a removable USB drive or other storage media located in a housing different from that of the reader device 106. Indeed, memory may be any non-transitory computer-readable medium that can store computer-executable instructions. Accordingly, references to a processor or computing device will be understood to include references to a collection of processors or computing devices or memories that may or may not operate in parallel.

The memory 112 stores information accessible by the one or more processors 110, including instructions 114 and data 116 that may be executed or otherwise used by the processor(s) 110. The data may include sensed characteristics from any of the tracking tags 102 and/or 104 received by the reader device 106. The memory 112 may be of any type capable of storing information accessible by the processor(s), including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The data 116 may be retrieved, stored or modified by processor(s) 110 in accordance with the instructions 114. For instance, although the claimed subject matter is not limited by any particular data structure, the data may be stored in computing device registers, in a relational database as a table having a plurality of different fields and records, XML documents or flat files. The data may also be formatted in any computing device-readable format.

The instructions 114 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

In some implementations, the tracking system 100 may further include a central server, such as one or more server computing devices 108 accessible by the one or more processors 110 of the reader device 106. In some implementations, one or more tracking devices in the tracking system 100, such as a tracking tag 104, may be configured to obtain and communicate data directly to the one or more server computing devices 108. The one or more server computing devices 108 may include one or more processors 120, memory 122 and other components typically present in general purpose computing devices. The one or more processors 120 may be the same or similar type as the one or more processors 110, and the memory 122 may be the same or similar type as the memory 112. The memory 122 stores information accessible by the one or more processors 120, including instructions 124 and data 126 that may be executed or otherwise used by the processor(s) 120. Data 126 and instructions 124 may be the same or similar type as the data 116 and instructions 114, respectively.

After detecting the beacon signals of one or more tracking tags 102 or 104, the reader device 106 may transmit the data from the tracking tags to the one or more server computing devices 108 through an existing connection or through a network. Thus, in this case the reader device 106 may include a transmitter module (not shown) that is configured for wired or wireless transmission to the server computing devices. The data may be received in a series of payloads (e.g., data packets) either continually, at one or more set intervals, or ad hoc whenever the tracking tags transmit. Thus, when there are multiple tracking tags, the data is effectively received as a plurality of separate data streams. A given payload (which may include one or more data packets) may include measurements taken at one or more time intervals, each of which may have a corresponding timestamp. In one scenario, the reader device 106 may include a transceiver including both a receiver and a transmitter, which is configured to receive beacon signals from the tracking tags 102 and 104 and also to send and receive information with the one or more server computing devices 108.

As discussed in more detail below, the one or more server computing devices 108 may be configured to track characteristics of the tracking devices to determine whether an event has occurred. An event may occur when one or more conditions for an event has been met for a tracked object (or tracking tag attached to that object). Once an event is determined to occur, the one or more server computing devices may trigger an event.

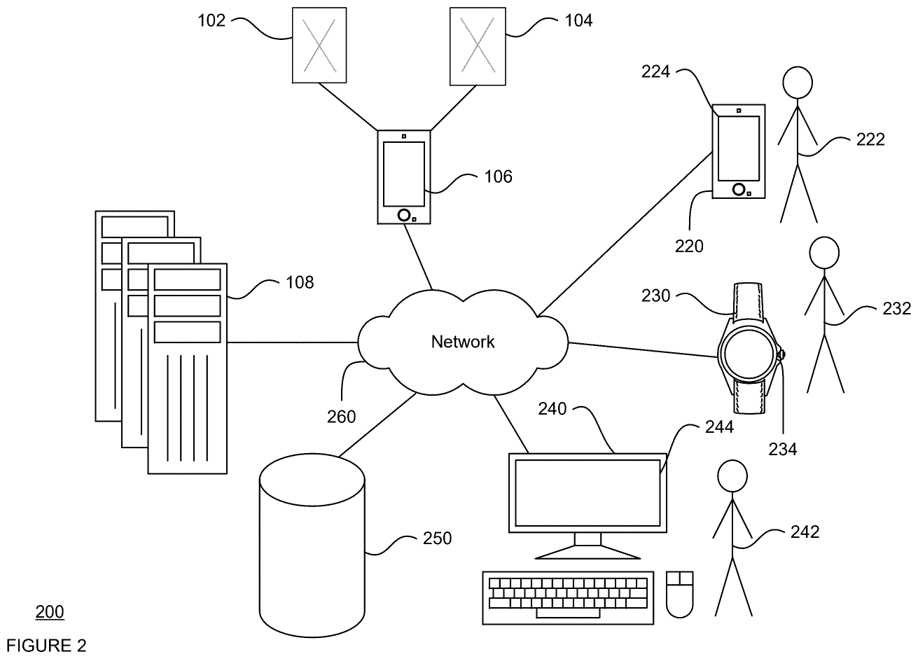

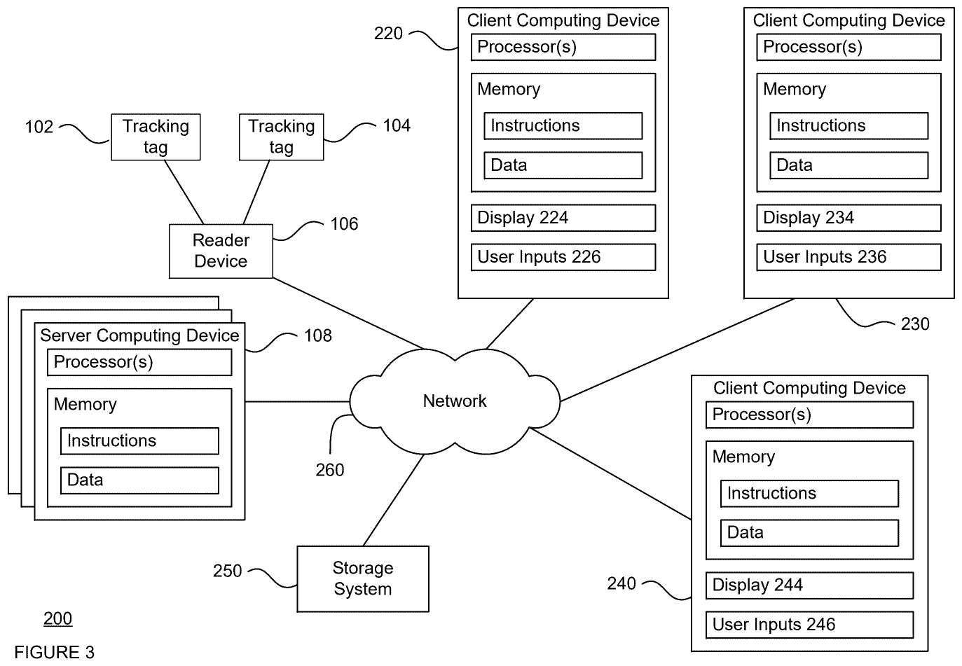

FIGS. 2 and 3 are pictorial and functional diagrams, respectively, of an example system 200 that includes a plurality of client computing devices 220, 230, 240 and a storage system 250 connected via a network 260. System 200 also includes tracking system 100, including tracking tags 102, 104, reader device 106, and server computing devices 108. Although only a few tags and computing devices are depicted for simplicity, a typical system may include significantly more.

Using the client computing devices, users, such as user 222, 232, 242, may view the location data on a display, such as displays 224, 234, 244 of respective client computing devices 220, 230, 240. As shown in FIG. 3, each client computing device 220, 230, 240 may be a personal computing device intended for use by a respective user and have all of the components normally used in connection with a personal computing device including a one or more processors (e.g., a central processing unit (CPU)), memory (e.g., RAM and internal hard drives) storing data and instructions, a display such as displays 224, 234, 244 (e.g., a monitor having a screen, a touch-screen, a head-mounted display, a smartwatch display, a projector, a television, or other device that is operable to display information), and user input devices 226, 236, 246 (e.g., one or more of a mouse, keyboard, touch screen and/or a microphone). The client computing devices may also include speakers, a network interface device, and all of the components used for connecting these elements to one another.

Although the client computing devices 220, 230, and 240 may each comprise a full-sized personal computing device, they may alternatively comprise mobile computing devices capable of wirelessly exchanging data with a server over a network such as the Internet. By way of example only, client computing device 220 may be a mobile phone or a device such as a wireless-enabled PDA, a tablet PC, a wearable computing device or system (e.g., a smartwatch or head-mounted display, or a netbook that is capable of obtaining information via the Internet or other networks. As an example, the user may input information using a small keyboard, a keypad, microphone, using visual signals (gestures) with a camera or other sensor, or a touch screen.

The client computing devices may enable a user to receive and view the various events. In some instances, a user may use a web browser to receive and view the various events discussed herein. For example, using the web browser, the client computing devices may access data from the reader device 106 and/or the one or more server computing devices 108 via the network 260. In other instances, a dedicated tracking application may be installed on one or more client computing devices. The application may enable a user of the client computing device to receive and view the various events discussed herein. For example, using the application, the client computing devices may access the data from the reader device 106 and/or the one or more server computing devices 108 via the network 260.

As with memory 112, storage system 250 can be of any type of computerized storage capable of storing information accessible by the one or more server computing devices 108, such as a hard-drive, memory card, ROM, RAM, DVD, CD-ROM, write-capable, and read-only memories. In addition, storage system 250 may include a distributed storage system where data is stored on a plurality of different storage devices which may be physically located at the same or different geographic locations. Storage system 250 may be connected to the computing devices via the network 260 as shown in FIG. 2, and/or may be directly connected to or incorporated into any of the client computing devices 220, 230, 240. The storage system 250 may store information about the tracking tags including, for example, location, status (e.g., activated and when), identifiers, last update, sensed characteristics (e.g., temperature, motion, light, pressure, location, object details, battery conditions, trip conditions, signal strength signal strength and/or other detectable characteristics of the tracking device tracked object or their environment), information about the object to which the tracking tag is attached (e.g., manufacturing data), and so on. In this regard, the information may be determined from received beacon signals provided to and updated at the storage system 250 by any of the one or more server computing devices 108 and/or client computing devices 220, 230, 240.

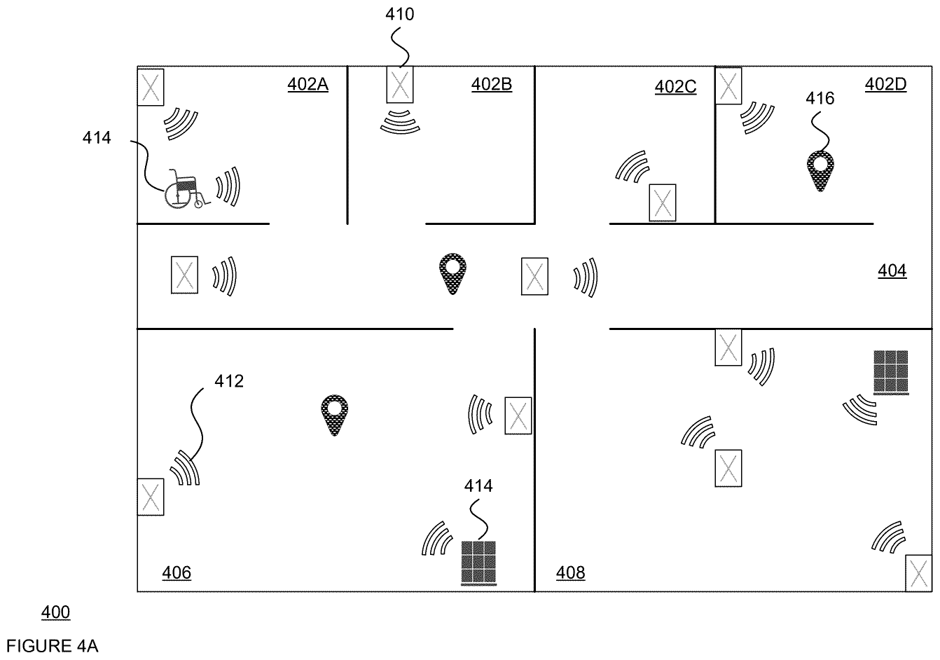

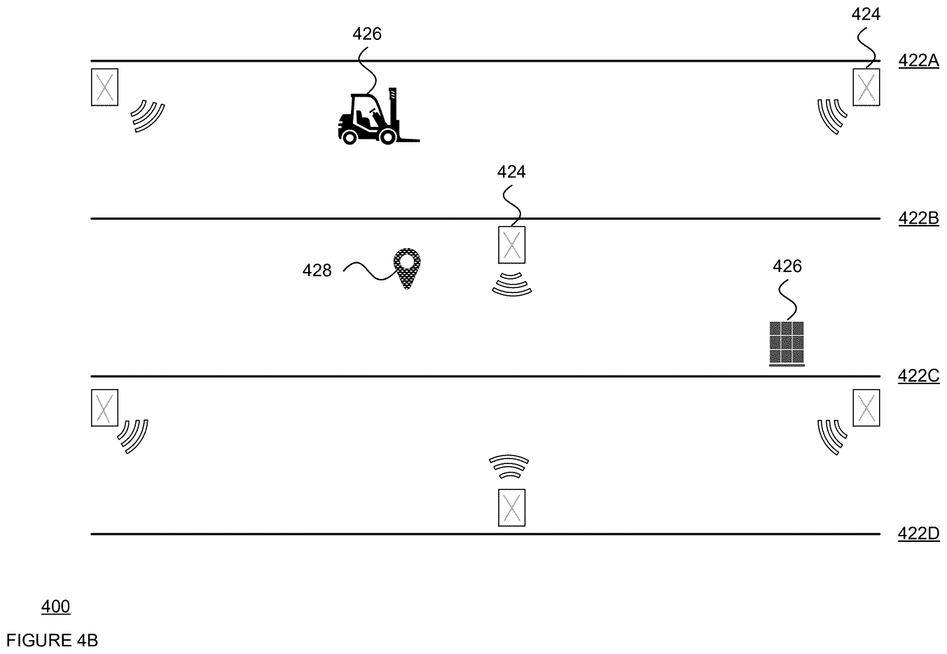

FIG. 4A illustrates one example 400 of a system having a number of tracking tags arranged in various locations of a building (e.g., a hospital). In this example, there may be a number of rooms 402A, 402B, 402C, 402D, such as patient rooms, along one side of a hallway 404. On the opposite side of the hallway 404 there is a storage room 406, such as to house equipment or supplies, as well as another room 408, which may be a meeting room, common area, rehab facility or the like. One or more fixed tracking tags 410 (e.g., line-powered) corresponding to the tracking tags 102 or 104 may be located in each room, including the hallway. Each fixed tracking tag 410 is configured to emit beacon signals 412 (e.g., RF signals in a selected frequency band according to a particular communication protocol). While the beacon signals 412 may appear directional, this need not be the case and the beacon signals may be transmitted omnidirectionally, for instance from a tracking tag 410 that is located on the ceiling, pillar or floor. In some implementations, the tracking tag 410 may be configured to emit beacon signals with the aforementioned sensed characteristics.

Tracking tags 414 may correspond to tracking tags 102 or 104 when placed on a variety of objects (e.g., a case of supplies as shown in storage room 406 or a wheelchair shown in room 402A). In some instances, the tracking tags may also be configured to emit beacon signals with sensed characteristics including information about conditions of the tracking tag or information associated with the object on which the tracking tag is applied (e.g., temperature, motion, light, pressure, location, object details, battery conditions, trip conditions, signal strength and/or other detectable characteristics of the tracking device, tracked object or their environment). Readers 416 may be found at various locations in the building, such as in a patient room, the storage room, the hallway or other location. Note that even if transmitted omnidirectionally, the beacon signals from a given tracking tag may be attenuated in a non-uniform manner due to the presence of walls, furniture, floors/ceilings, equipment, etc.

FIG. 4B illustrates another example 420 of a system having a number of fixed tracking tags positioned along different aisles in a warehouse setting. In this example, there are a number of aisles 422A, 422B, 422C, 422D, although there may be more (or fewer) aisles, and the aisles may be arranged in other configurations than what is shown. Here, fixed tracking tags 424 are located at different places for the aisles, such as along aisle end caps, along the ceiling (or floor), on shelves, storage lockers, cabinets or other places along the aisle, etc. Similar to FIG. 4A, fixed tracking tags 426 are placed on or otherwise associated with different objects, such as a pallet of equipment or a forklift that retrieves items from their locations in the warehouse. As above, the fixed tracking tags are configured to transmit beacon signals that are detectable by one or more reader devices 428 (e.g., line or battery powered).

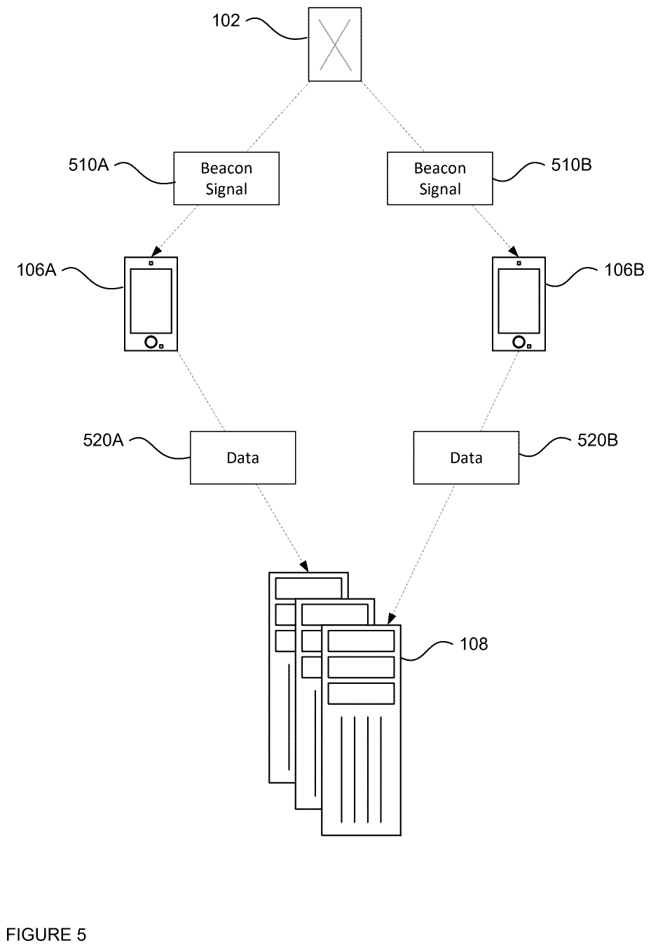

For example, referring to FIG. 5, tracking tag 102 may transmit beacon signals 510A, 510B which may be received by reader devices 106A, 106B (which may be configured the same or similarly to reader device 106). Each reader device in turn may transmit data 520A, 520B to the one or more server computing devices 108. As noted above, this data may provide information about the beacon signals 510A, 510B received from the tracking tag 102. Such information may include tracking tag identifiers, state information (e.g., whether or not the tracking tag has moved or is moving, sensor data or measurements, whether one or more thresholds have been met, etc.), etc. Thus, in this example, each of the reader devices 106A, 106B is within range of the tracking tag 102.

Sometimes, payloads may be received out of order. For instance, the system may include different types of the aforementioned reader devices. As an example, one type of reader device may be connected to power (e.g., line powered) and another type of reader device may run on battery power or other internal power source. Because battery powered reader devices may send signals periodically and line powered reader devices may send signals continuously, at least some signals (and respective payloads) may be received by the server computing devices out of order. For example, line-powered devices are able to continuously scan for tracking devices and upload data in near-real-time, battery powered devices may scan and upload data at some periodic interval, e.g., every 15 minutes. In addition, reader devices often scan more frequently than they upload data: for example, they may scan every minute and upload data every 10 minutes.

For example, referring to FIG. 5, the two reader devices 106A, 106B may each be battery powered and may be within range of the tracking tag 102. Reader device 106A may collect data from beacon signals (e.g., beacon signals 510A) sent by the tracking tag 102 at timestamps 0:05, 0:06, 0:07, . . . , 0:10, and may send all of this data to the one or more server computing devices 108 at timestamp 0:10. Reader device 106B may collect data from beacon signals (e.g., beacon signals 510B) sent by the tracking tag 102 at timestamps 0:01, 0:02, . . . , 0:10, and may send all of this data to the one or more server computing devices 108 at timestamp 0:20. At or immediately after timestamp 0:10 the one or more server computing devices may thus have data about tracking tag 102 from timestamps 0:05-0:10, and may generate any necessary events from that data. However, at or immediately after 0:20, the one or more server computing devices receive additional data about tracking tag 102. Accordingly, the server computing devices now have additional data from timestamps 0:01-0:10 for the tracking tag 102. Thus, the data from timestamps 0:01-0.05 is received out of order. In addition, the server computing devices may now (at or immediately after timestamp 0:20) need to re-process all of the data from timestamps 0:05-0:10 in order to determine whether there are any conditions that correspond to an event that triggers an event on the full set of data (e.g., the data from both reader devices 106A and 106B). At the same time, depending on the data received from reader device 106B, the events generated based on the data received from reader device 106A at timestamps 0:05-0:10, may have been incorrect or false events.

To reduce the likelihood of false events and more efficiently process out of order payloads, the server computing devices may implement various software modules, queues and tables. The plurality of software modules may be stored in the memory of the server computing devices and/or the storage system 250. As discussed further below, these software modules may be used to process inputs such as payloads and produce outputs such as events.

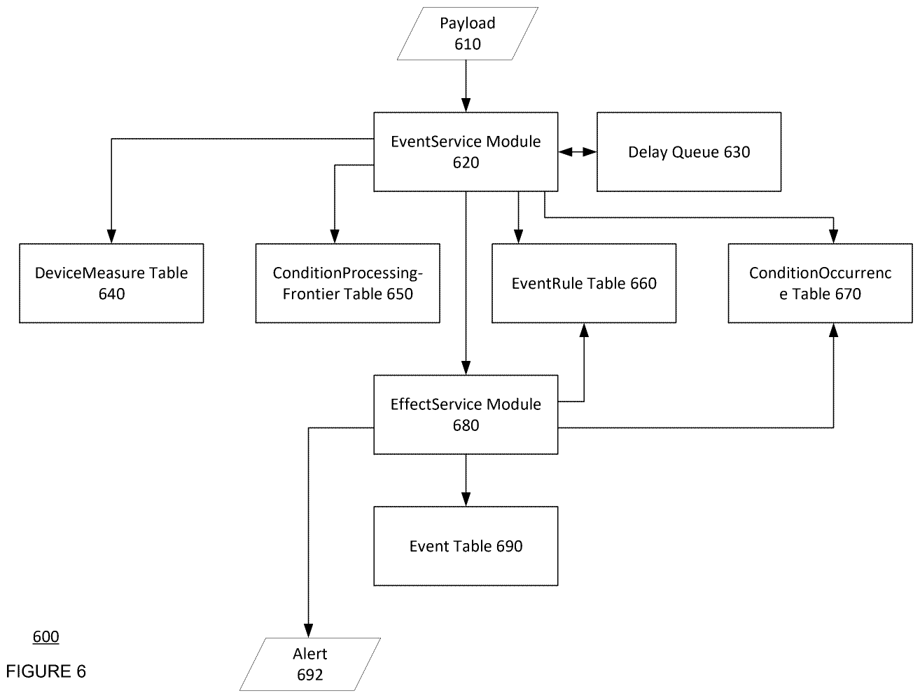

FIG. 6 depicts an example functional diagram 600 of a plurality of software modules receiving a payload 610 and producing an alert 692. The plurality of software modules may include an EventService Module 620 and an EffectService Module 680. These software modules may be used to read and write data to a Delay Queue 630, DeviceMeasure Table 640, a ConditionProcessingFrontier Table 650, a ConditionOccurrence Table 670, and an Event Table 690. Again, the one or more server computing devices 108 may access the plurality of software modules, queues, and tables as needed in order to perform the functions described further below.

The EventService Module 620 may be configured to receive and process the payloads, e.g., payload 610, as further discussed below. As part of processing the payloads, the EventService Module 620 may query the Delay Queue 630, EventRule Table 660, the ConditionOccurrence Table 670, and/or DeviceMeasure Table 640. As a result of processing the payloads, the EventService Module 620 may cue the EffectService Module 680.

When a new payload is received, the EventService Module 620 may enter the payload into the Delay Queue 630 in order to delay processing the payload and account for some out of order payloads. For instance, each payload, including payload 610, may include one or more values corresponding to one or more sensed characteristics for the tracked object and a timestamp corresponding to when the payload was originally generated or payload timestamp. The payload may stay in the Delay Queue 630 until a delay time has expired or been met. The delay time for each payload may be measured from the payload timestamp of the payload. Thereafter, the payload may be further processed by the EventService Module 620 as discussed below.

This delay may provide the one or more servers computing devices 108 with additional time to wait for any out of order payloads and potentially avoid generating events and alerts before an out of order payload is received that would cancel the event. As an example, in the systems described herein, approximately 17% of payloads may be received out of order. Of these, approximately 15% may be delayed more than 10 seconds, approximately 5% may be delayed by more than 3 minutes, and approximately 2 percent may be delayed by more than 30 minutes. Thus, a 3-minute delay time in processing payload may reduce out of order processing rate of received payloads to approximately 5% whereas a 30 minute delay time may reduce the out of order processing rate of received payloads to approximately 2%. Of course, smaller or greater delays (e.g., 10 minutes, 40 minutes, or more or less) may also be used. In addition, different delay time options may be set for different types of payload (categorized by asset or device or trip) as some conditions may result in more time-sensitive effects (e.g., food may take longer to spoil than medicines).

The EventService Module 620 may record data in the DeviceMeasure Table 640 each time a payload is retrieved from the Delay Queue 630 after the delay time for that payload has expired. Thus, the DeviceMeasure table may contain data such as device identifiers (identifying specific tracked objects), one or more values, and timestamps (including a timestamp that the data was written to the table as well as a timestamp of the payload). These values may include any of the aforementioned sensed characteristics (temperature, motion, light, pressure, location, object details, battery conditions, trip conditions, signal strength and/or other detectable characteristics of a tracking device and/or tracked object or its environment) as well as a calculation derived from the sensed characteristics, and/or payload metadata (e.g., signal strength, timing, etc.). In this regard, the DeviceMeasure table may store data received from various devices (e.g., reader devices, tracking tags, tracked objects, etc.). In some instances, the DeviceMeasure table also may store measurements reflecting connectivity status, for instance, a message from the WiFi radio on the device describing a connection to a nearby access point.

The EventService Module 620 may refer to the ConditionProcessingFrontier Table 650 in order to determine whether payloads are out of order. In this regard, the ConditionProcessingFrontier Table 650 may identify the most up-to-date (i.e., latest in time) payload timestamp of a payload processed with regard to an EventRule. As such, the ConditionProcessingFrontier Table 650 may store device identifiers, EventRule identifiers, and a frontier timestamp value.

The EventRule Table 660 may store EventRules. Each EventRule may include a bundle of one or more conditions. Each condition may specify triggering criteria or requirements for a measurand, such as a duration requirement discussed further below. Each condition may describe a measurand and value or a range of values for the measurand that satisfy the triggering criteria. An event may be triggered when all of the requirements of an EventRule are satisfied. Each EventRule also may describe one or more effects (e.g., generating alerts and other events) that should be triggered by the event. Each EventRule also may define a cooldown, which may be a period of time that the system will wait after generating an event or other effect based on the listed conditions, before making another event or effect based on those conditions.

The conditions may include one or more (e.g., combinations) of a minimum sensed characteristic, a maximum sensed characteristic, a duration (e.g., amount of time), and a distance to a geofence. The conditions may be predetermined or set based on user input. For example, an event may be determined to occur when conditions such as (1) a temperature is greater than 5° C. for at least 30 minutes and (2) the tracked object is on a trip, which may indicate overheating of a tracked object such as a cooled package or storage compartment, are met. As another example, an event may occur when conditions such as (1) no motion is detected for 10 minutes, (2) device locations are in a geofence, and (3) the tracked object is on a trip, which may indicate that a tracked object such as a package is out for delivery, are met. As another example, an event may occur when conditions such as (1) a threshold amount of light is detected from inside a tracked object such as a package and (2) the tracked object is on a trip, which may indicate unexpected opening of the package or tampering, are met. As another example, an event may occur when conditions such as (1) a threshold amount of light is detected from inside a package and (2) device locations are in a destination geofence, which may indicate opening of the package after delivery or receipt, are met. As another example, conditions to trigger an event may include a shock event (e.g. accelerometer or gyroscope data indicates that a tracked object was dropped which could be a potential problem for a fragile object). As another example, conditions to trigger an event may include a tracked object reaching a destination for a trip. Again, once the one or more server computing devices 108 determine that any of these events have occurred, the one or more server computing devices 108 may generate an event and/or other effects as discussed further below. Many other events, conditions and scenarios are possible.

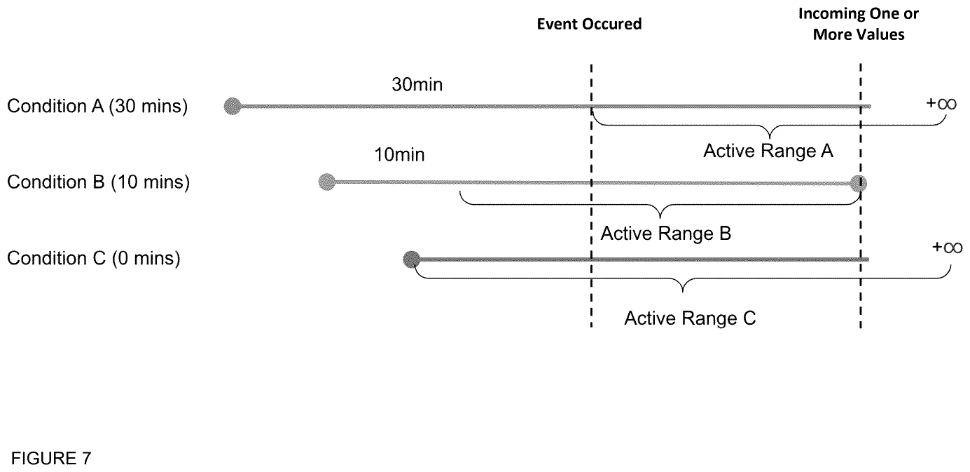

FIG. 7 provides an example of conditions A, B, C and assumes that payloads are received in order for the same tracked object. Condition A has a duration requirement of 30 minutes (e.g., a condition must occur for at least 30 minutes before resulting in an event and triggering an alert), condition B has a duration requirement of 10 minutes (e.g., a condition must occur for at least 10 minutes before resulting in an event and triggering an alert), and condition C has no duration requirement (e.g., a condition must simply occur and this occurrence results in an event and triggering an alert). For simplicity, condition A may include temperatures above 5° C., condition B may occur when the tracked object is moving, and condition C may occur when an ambient lighting condition changes.

In this example, for condition A, 30 minutes after a payload that includes a value indicating a temperature above 5° C., an event occurs and an alert for condition A becomes active for that event. When a new payload is received that includes a value indicating a temperature above 5° C., the alert for condition A remains active.

For condition B, 10 minutes after a payload that includes a value indicating that the tracked object is moving is identified, an event occurs and an alert for condition A becomes active for that event. When a new payload is received that includes a value indicating that the tracked object is not moving, the alert for condition B becomes inactive.

For condition C, as soon as a payload that includes a value indicating that an ambient lighting condition has changed is identified, an event occurs and an alert for condition C becomes active for that event. When a new payload is received that includes a value indicating that an ambient light condition has or has not changed, the alert for condition C may remain active as there is no duration requirement.

Each EventRule that is stored in the EventRule Table 660 may be specified to a certain organization (user of the system), and may be grouped by Trips, Assets, or Devices. Each EventRule also may specify what type of devices it should apply to. As an example, “Device” may refer to a tracking device such as a tracking tag (e.g., tracking tag 102 as described above). For instance, if an EventRule is applied with a Trips grouping, then the EventRule will apply to all tracked objects on the same trip, and any device from the trip can trigger the event. A Trip may refer to the concept of some physical thing (e.g., a box, an infusion pump, a crate of apples, a truck, etc.) moving from an origin location to some destination location. An Asset may refer to a tracked object (e.g., a physical thing that is being tracked such as a crate of apples, an infusion pump, etc.). The Devices, Trips, or Assets that the EventRule is applied to can also be filtered by Category. For instance, if an Assets grouping is filtered to the “cold chain” Category, then all assets associated (directly or indirectly) with a “cold chain” Category will be included.

The EffectService Module 680 may be configured to perform one or more effects defined by an EventRule upon detection of an event based on that event rule, in response to cues from the EventService Module 620. This may include writing a new event to the Event Table 690. Each event in the event table may include information identifying a tracked object, the type of event, conditions that supported the event, as well as a time at which all the conditions for the event were initially met. In addition to writing new events, the EffectService Module 680 may also generate an alert 692. This alert may notify a user directly (e.g., via an email or SMS message), update the tracking status of a device or may display a notification in a web dashboard that the user may access asynchronously. In some instances, the notification may be a “toast notification” or a non-modal, unobtrusive window element that is used to display a brief, auto-expiring window of information to a user. Events may also be saved for later retrieval and review so that events can be viewed/queried at any time, e.g., via an API, etc.

The ConditionOccurrence Table 670 may store occurrences of conditions for tracked objects. Each entry in the ConditionOccurrence Table 670 may include a device identifier, an EventRule identifier, a condition identifier (e.g., an identifier for the specific condition of the EventRule), a start time for the condition of the EventRule, and an end time. In this regard, if the end time field is empty for an entry, this may indicate that the condition is still ongoing (e.g., active or pending).

### Example Methods

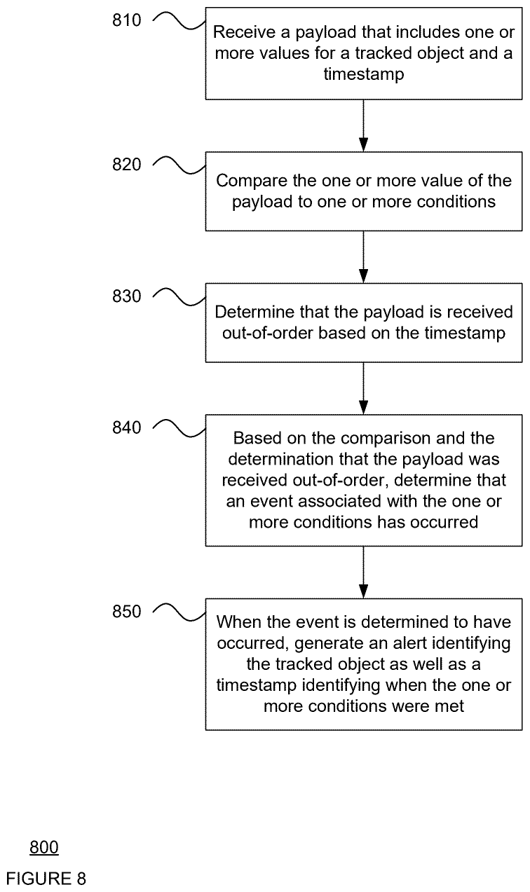

As noted above, the server computing devices may use received signals to determine whether an event has occurred for a tracked object and generate a corresponding event. FIG. 8 depicts an example flow diagram 800 of a method for generating events when payloads are received out of timestamp order that may be implemented by one or more processors of the one or more server computing devices 108. While FIG. 8 shows blocks in a particular order, the order may be varied and multiple operations may be performed simultaneously. Also, operations may be added or omitted.

Returning to FIG. 8, at block 810, a payload including a value for a tracked object and a timestamp is received. In some instances, the one or more server computing devices 108 may receive a signal including a payload. This signal may be received from any of the devices in the system 100 (e.g., a tracking tag and/or reader device) and may identify one or more values about a particular tracking device and/or tracked object (e.g., device identifier). For instance, the EventService Module 620 receives a signal, such as a payload 610 for a tracked object. In this example, the payload 610 may include one or more values corresponding to one or more sensed characteristics for the tracked object and a timestamp corresponding to when the payload was originally generated or payload timestamp.

Upon receipt of a new payload, the one or more server computing devices 108 may enter the payload into a delay queue. For example, the EventService Module 620 may enter the payload 610 into the Delay Queue 630. At the same time or immediately before or after, the EventService Module 620 may create or generate a new entry in the DeviceMeasure Table 640. The entry may include a device identifier for the tracked object, one or more values of the payload (corresponding to the sensed characteristics included in the payload, a calculation derived from the sensed characteristics, and/or payload metadata), the payload timestamp, and a timestamp of the entry or entry timestamp (corresponding to a time when the entry was written to the DeviceMeasure Table 640).

As noted above, once the delay time for a payload has expired or been met, the server computing devices may process the payload. For example, the one or more server computing devices 108 may update the ConditionProcessingFrontier Table 650. For example, for any EventRules associated with the one or more values of the payload, the EventService Module 620 may add a new entry (if there is no existing entry for a particular condition) or update the frontier timestamp value with the payload timestamp of an existing entry for the condition and the payload. This frontier timestamp value may only need to be updated to the incoming payload timestamp if the payload timestamp is more advanced (e.g., later in time) than the one recorded in the table. In this regard, the ConditionProcessingFrontier Table 650 may always indicate the payload with the last in time payload timestamp for the condition and tracked object. As such, if a payload timestamp of a newly received payload is less than the frontier timestamp value, this may indicate that the incoming payload is out of order. Each EventRule may have a different frontier due to a configurable delay option in the EventRule, which allows buffering payload for a configurable amount of time, after being recorded, before being processed by the event detection system. As a result, EventRules for different tracking devices and/or tracked objects may have different delay options and will have different frontier values.

Returning to FIG. 8, at block 820, the one or more values of the payload may be compared to one or more conditions. As discussed further below, the one or more server computing devices 108 may use the EventService Module 620 to compare the one or more value of the payload to the one or more conditions of the EventRules in the EventRule Table 660. Depending on the results (and whether the payload was received out of order), the EventService Module 620 may take various different actions or no actions as discussed further below.

Returning to FIG. 8, at block 830, that the payload is received out of order is determined. The one or more server computing devices 108 may also use the EventService Module 620 to determine whether the payload is received out of order. The EventService Module 620 may query the ConditionProcessingFrontier Table 650 and compare the payload timestamp to the frontier timestamp value of any entries for the tracked object and any EventRules corresponding to the one or more values of the payload.

### Payloads Received in Order

In the simplest case, a payload is received in order. This may occur when the payload timestamp is later than a frontier time for an entry for an EventRule corresponding to the tracking device and/or the tracked object. When the payload is received in order, the EventService Module 620 may then compare the one or more value of the payload to the one or more conditions of the EventRules in the EventRule Table 660.

When the one or more values of the payload meets at least one of the one or more conditions of an EventRule for the tracked object, the EventService Module 620 may either add an entry or update an existing entry for the condition for the tracked object in the ConditionOccurrence Table 670 or take no action. For instance, if there is not already an entry for the condition for the tracked object or not already an entry for the condition without an end date, the EventService Module 620 may make a new entry for the condition. If there is already an entry for the condition for the tracked object without an end date, the EventService Module 620 may take no action.

As a simple example, one or more conditions of an EventRule include (1) a temperature is greater than 5° C. and (2) for at least 30 minutes, and the one or more values of the payload may indicate a temperature of 10° C. In this example, the one or more values meet condition (1). As such, if there is not already an entry for condition 1 for the tracked object or not already an entry for the condition 1 without an end date, the EventService Module 620 may take no action.

When the one or more values of the payload does not meet any of the one or more conditions of an EventRule for the tracked object, the EventService Module 620 may either update an existing entry for the condition for the tracked object in the ConditionOccurrence Table 670 or take no action. For instance, if there is already an entry for any of the one or more conditions for the tracked object without an end date, the EventService Module 620 may add an end date to the entry. If there is not already an entry for the condition for the tracked object without an end date, the EventService Module 620 may take no action.

Referring to the simple example above, one or more conditions of an EventRule include (1) a temperature is greater than 5° C. and (2) for at least 30 minutes, and the one or more values of the payload may indicate a temperature of 0° C. In this example, the one or more values does not meet condition (1). As such, if there is an entry for condition 1 for the tracked object, without an end date, the EventService Module 620 may enter the timestamp of the payload into the end date field. Alternatively, if there is not already an entry for condition 1 for the tracked object, the EventService Module 620 may take no action.

### Payloads Received Out of Order

As described above, the one or more server computing devices 108 may also be able to handle out of order payloads when using received signals to determine whether an event has occurred and generate a corresponding event. For example, an out of order payload may occur when the frontier timestamp value of a condition in the ConditionProcessingFrontier Table 650 for the tracked object corresponding to the one or more values of the payload is later in time than the payload timestamp. In this regard, the EventService Module 620 may query one or both of the DeviceMeasure Table 640 and the ConditionOccurrence Table 670.

At block 840, in response to the value of the payload matching one of the one or more conditions and the determination that the payload was received out of order, that an event associated with the one or more conditions has occurred is determined. As noted above, the one or more server computing devices 108 may determine whether an event for a tracked object has occurred. For example, if the ConditionOccurrence Table 670 contains one or more entries that match all of the one or more conditions of an EventRule in the EventRule Table 660, the server computing devices may determine that an event has occurred for the tracked object. Referring to the simple example above, one or more conditions of an EventRule include (1) a temperature greater than 5° C. and (2) for at least 30 minutes. If an entry in the ConditionOccurrence Table 670 meets both conditions (1) and (2), the EventService module may cue (or send a message to) the EffectService Module 680. In this example, if an entry in the ConditionOccurrence Table 670 includes a start time that is greater than 30 minutes before the current time for a tracked object, the EventService module may send a message to the EffectService module.

The EffectService Module 680 may receive messages from the EventService Module 620 over a publish/subscribe connection and may call subsidiary services to execute events or other effects based on the content of the messages received from the EventService module and/or based on the content of the EventRule table. Publish/subscribe is a message queue service. One example is Pub/Sub service provided by Google Cloud Platform. Another example is the Simple Queue Service provided by Amazon Web Services. Events and events or other effects may be largely independent. Any event, or set of events, should be able to trigger any event or other effect (or set of events or other effects).

At block 850 of FIG. 8, when the event is determined to have occurred, an alert identifying the tracked object as well as a timestamp identifying when the one or more conditions were met is generated. In response to determining that an event for a tracked object has occurred, the one or more server computing devices 108 may generate an event, and in some instances, and a corresponding alert. For instance, the message from the EventService Module 620 may cause the EffectService Module 680 to generate one or more events, alerts, or other effects. For example, the EventService Module 620 may write a new event to the Event Table 690. As noted above and discussed further below, the alert 692 may be provided for display to a user on a client computing device.

For example, the EffectService Module 680 may generate an event when the EffectService Module both (a) receives a message from the EventService Module 620 and (b) verifies that an entry in the ConditionOccurrence Table 670 matches an EventRule in the EventRule Table 660. Each new event may be written to the Event Table 690.

The EffectService Module 680 may check the ConditionOccurrence Table 670 to find out whether the conditions that would support a given event exist at a given point in time. Optionally, the EffectService Module 680 may be split into several parts, each of which independently checks the ConditionOccurrence Table 670. When the EffectService Module 680 finds conditions corresponding to an event that would support a given event, the EffectService Module 680 generates that event and a corresponding alert. The alert may provide information identifying the tracked object that met the one or more conditions as well as time information indicating a time at which the one or more conditions for an event were initially met.

As noted above, these alerts may be provided for display to a user on a client computing device. Such an event could include sending an email to the user about an issue; sending a SMS message; ending a Trip in the system; showing an Event in the web dashboard so the user can see the issue that has come up; and/or re-calculating an ETA of a Trip based on a device having passed some significant landmark.

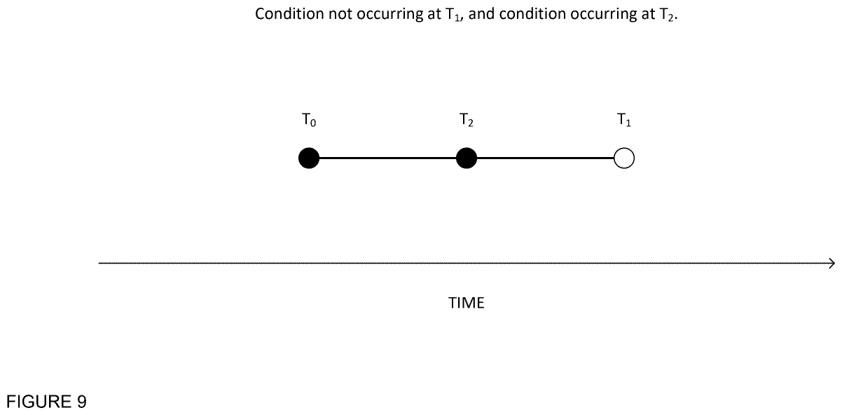

FIGS. 9-21 represent example timelines for conditions and various situations in which out of order payloads may be received and how the payloads and events may be processed by the one or more servers computing devices 108. These are only a small number of illustrative examples of the potential ways out of order payloads may be received and processed by the one or more server computing devices 108 and should not be considered limiting.

For simplicity, these examples assume all payloads are received for the same tracked object and a single condition, though the system may be capable of processing payloads for any number of different tracked objects and conditions. Each example includes a timeline and three timestamps received in the order T₀, T₁, T₂. In this example, T₀ represents a payload timestamp for a first payload that indicates that the condition was occurring and started at T₀. In this regard, the ConditionOccurrence Table 670 may include an entry for the condition with a start time of T₀. T₁ represents a payload timestamp for a second payload. T₂ represents a payload timestamp of a third payload. Thus, the relative positioning of the timestamps along the timeline indicates the relative times of the payload timestamps of each of the three payloads. The circles along the timeline also represent the corresponding values in the payloads either meeting a condition (solid circle) or not meeting a condition (open circle). Thus, in all examples, the one or more values of the payload with payload timestamp T₀ indicates that the condition was occurring at the payload timestamp of T₀.

Turning to FIG. 9, in this example, T₂ is between T₀ and T₁, indicating that T₂ is earlier in time than T₁ and also later in time than T₀. In this example, one or more values of the second payload indicates that at T₁ the condition was not occurring, and the one or more values of the third payload indicates that at T₂ the condition was occurring. In this example, the end time for the entry for the condition in the ConditionOccurrence Table 670 may be T₁. In this example, the one or more servers computing devices 108 may ignore the third payload and take no additional action with the third payload.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload received at T₁ or maybe a downgraded alert that provides information indicating that additional information has been received for the condition and the prior alert is still relevant. In still other instances, if the EffectService Module 680 may determine whether an event for the condition already exists and if not, add an event for the EventRule to the Event Table 690. The EffectService Module 680 may also generate an alert.

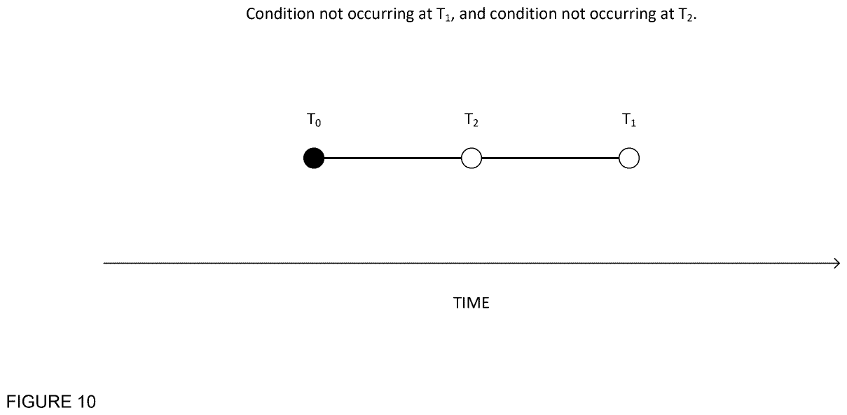

Turning to FIG. 10, in this example, T₂ is between T₀ and T₁, indicating that the payload timestamp for the payload received at T₂ is earlier in time than T₁ and also later in time than T₀. In this example, one or more values of the payload received at T₂ indicates that the condition was not occurring, and one or more values of the payload received at T₂ indicates that the condition was not occurring.

In this example, the one or more servers computing devices 108 may take additional action. For example, the EventService Module 620 may update the end time for the entry for the condition in the ConditionOccurrence Table 670. In this example, the updated end time may be the payload timestamp of the payload received at T₂.

In some instances, the one or more values of the third payload indicating that the condition is no longer occurring may result in an event in the Event Table 690 being canceled. For instance, the EventService Module 620 may send a message to the EffectService Module 680 indicating that an EventRule is no longer met. The EffectService Module 680 may determine whether an event for the condition already exists and if so, cancel that event and any associated alert. This may involve, for example, flagging the event as a false positive and sending a supplemental alert or other notification for display to a user indicating that the prior alert was a false positive, is no longer correct, has been canceled, etc.

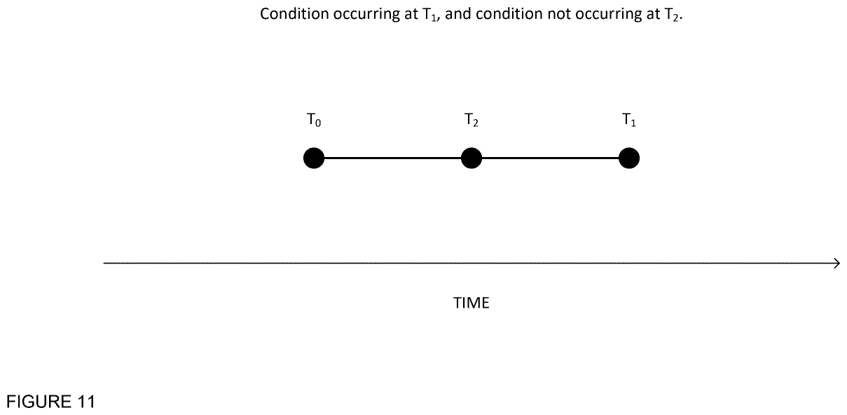

Turning to FIG. 11, in this example, T₂ is between T₀ and T₁, indicating that T₂ is earlier in time than T₁ and also later in time than T₀. In this example, one or more values of the second payload indicates that at T₁ the condition was occurring, and the one or more values of the third payload indicates that at T₂ the condition was occurring. In this example, the one or more servers computing devices 108 may ignore the third payload and take no additional action with the third payload.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload received at T₁ or maybe a downgraded alert that provides information indicating that additional information has been received for the condition and the prior alert is still relevant. In still other instances, if the EffectService Module 680 may determine whether an event for the condition already exists and if not, add an event for the EventRule to the Event Table 690. The EffectService Module 680 may also generate an alert.

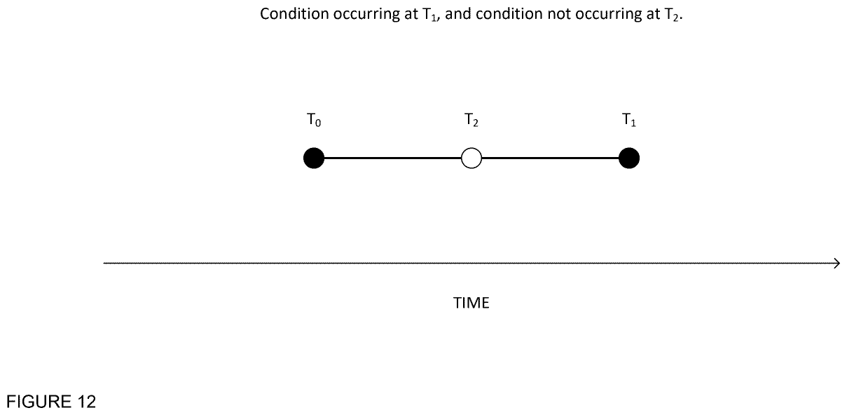

Turning to FIG. 12, in this example, T₂ is between T₀ and T₁, indicating that T₂ is earlier in time than T₁ and also later in time than T₀. In this example, one or more values of the second payload indicates that at T₁ the condition was occurring, and the one or more values of the third payload indicates that at T₂ the condition was not occurring. As such, the one or more servers computing devices 108 may take additional action. For example, the EventService Module 620 may add an end time to the entry for the condition in the ConditionOccurrence Table 670. In this example, the end time may be the payload timestamp of the payload received at T₂. In addition, the EventService Module 620 may create a new entry for the condition in the ConditionOccurrence Table 670 with a start time of the payload timestamp of the payload received at T₁.

In some instances, the one or more values of the third payload indicating that the condition is no longer occurring may result in an event in the Event Table 690 being canceled. For instance, the EventService Module 620 may send a message to the EffectService Module 680 indicating that an EventRule is no longer met. The EffectService Module 680 may determine whether an event for the condition already exists and if so, cancel that event and any associated alert. This may involve, for example, flagging the event as a false positive and sending a supplemental alert or other notification for display to a user indicating that the prior alert was a false positive, is no longer correct, has been canceled, etc.

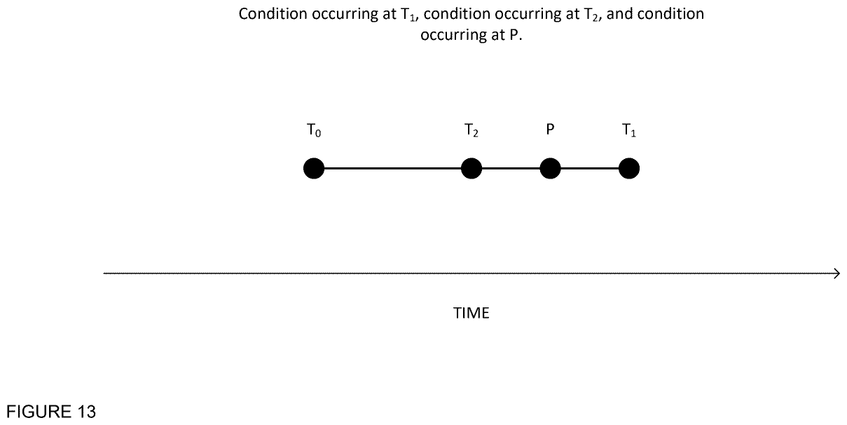

Turning to FIG. 13, in this example, T₂ is between T₀ and T₁, indicating that T₂ is earlier in time than T₁ and also later in time than T₀. In addition, a fourth payload (e.g., an “intervening” payload) was received (before the payload received at T₂ was received) with a payload having a payload timestamp P between T₂ and T₁. In this example, one or more values of the second payload indicates that at T₁ the condition was occurring, and the one or more values of the third payload indicates that at T₂ the condition was occurring. The fourth payload may also include one or more values indicating the condition was occurring at P. In this example, the one or more servers computing devices 108 may ignore the third payload and take no additional action with the third payload.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload received at T₁ or maybe a downgraded alert that provides information indicating that additional information has been received for the condition and the prior alert is still relevant. In still other instances, if the EffectService Module 680 may determine whether an event for the condition already exists and if not, add an event for the EventRule to the Event Table 690. The EffectService Module 680 may also generate an alert.

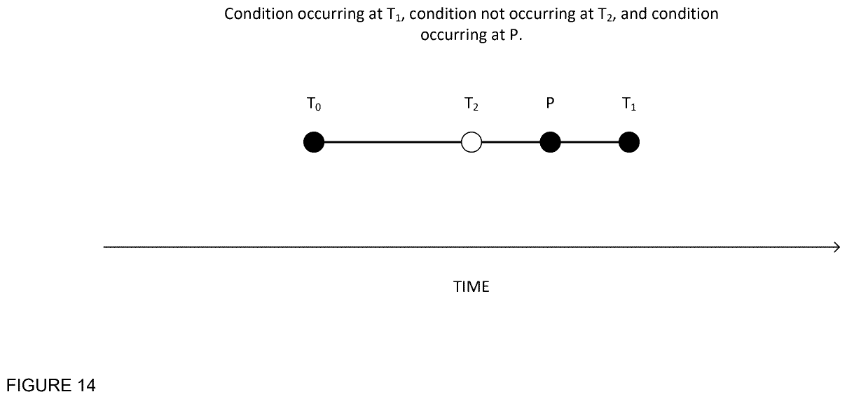

Turning to FIG. 14, in this example, T₂ is between T₀ and T₁, indicating that T₂ is earlier in time than T₁ and also later in time than T₀. In addition, a fourth payload (e.g., an “intervening” payload) was received (before the third payload was received) with a payload having a payload timestamp P between T₂ and T₁. In this example, one or more values of the payload received at T₁ indicates that the condition was occurring, and one or more values of the payload received at T₂ indicates that the condition was not occurring. The fourth payload may also include one or more values indicating the condition was occurring at P.

In this example, the one or more servers computing devices 108 may take additional action. For example, the EventService Module 620 may add an end time to the entry for the condition in the ConditionOccurrence Table 670. In this example, the updated end time may be T₂. In addition, the EventService Module 620 may create a new entry for the condition in the ConditionOccurrence Table 670 with a start time of P.

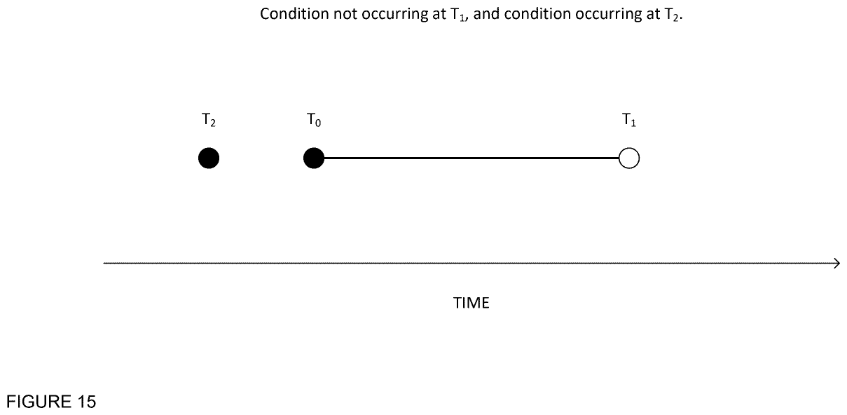

Turning to FIG. 15, in this example, T₂ is before T₀ and T₁, indicating that T₂ is earlier in time than T₁ and also earlier in time than T₀. In this example, one or more values of the second payload indicates that at T₁ the condition was not occurring, and the one or more values of the third payload indicates that at T₂ the condition was occurring. In this example, the end time for the entry for the condition in the ConditionOccurrence Table 670 may be T₁.

In this example, the one or more servers computing devices 108 may take additional action. For example, the EventService Module 620 may update a start time for the entry for the condition in the ConditionOccurrence Table 670. In this example, the start time may be updated to T₂.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload or maybe a downgraded alert that provides information indicating that additional information has been received for the condition and the prior alert is still relevant.

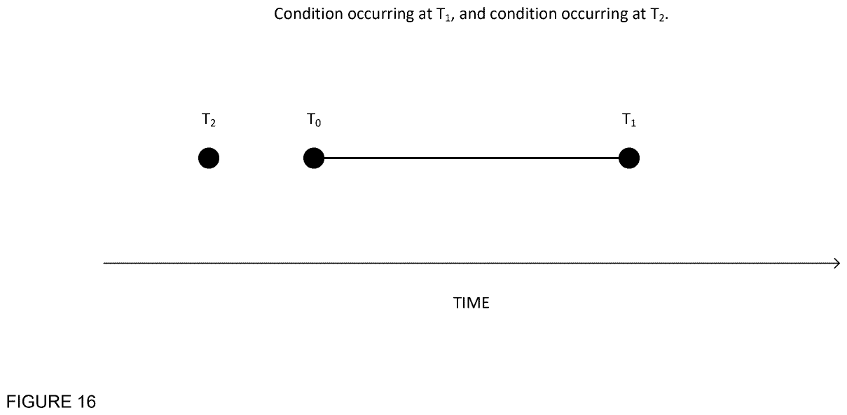

Turning to FIG. 16, in this example, T₂ is before T₀ and T₁, indicating that T₂ is earlier in time than T₁ and also earlier in time than T₀. In this example, one or more values of the second payload indicates that at T₁ the condition was occurring, and the one or more values of the third payload indicates that at T₂ the condition was occurring.

In this example, the one or more servers computing devices 108 may ignore the third payload and take no additional action with the third payload. Alternatively, the one or more server computing devices 108 may take additional action. For example, the EventService Module 620 may update a start time for the entry for the condition in the ConditionOccurrence Table 670. In this example, the start time may be updated to T₂.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload received at T₁ or maybe a downgraded alert that provides information indicating that additional information has been received for the condition and the prior alert is still relevant. In still other instances, if the EffectService Module 680 may determine whether an event for the condition already exists and if not, add an event for the EventRule to the Event Table 690. The EffectService Module 680 may also generate an alert.

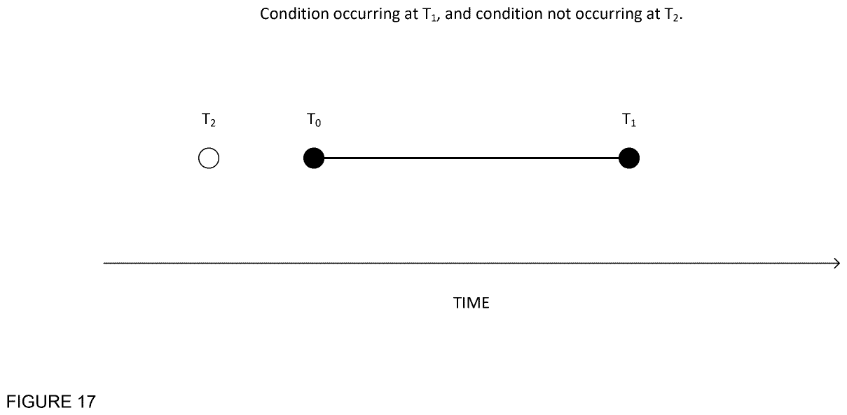

Turning to FIG. 17, in this example, T₂ is before T₀ and T₁, indicating that T₂ is earlier in time than T₁ and also earlier in time than T₀. In this example, one or more values of the second payload indicates that at T₁ the condition was not occurring, and the one or more values of the third payload indicates that at T₂ the condition was not occurring. In this example, the one or more servers computing devices 108 may ignore the third payload and take no additional action with the third payload.

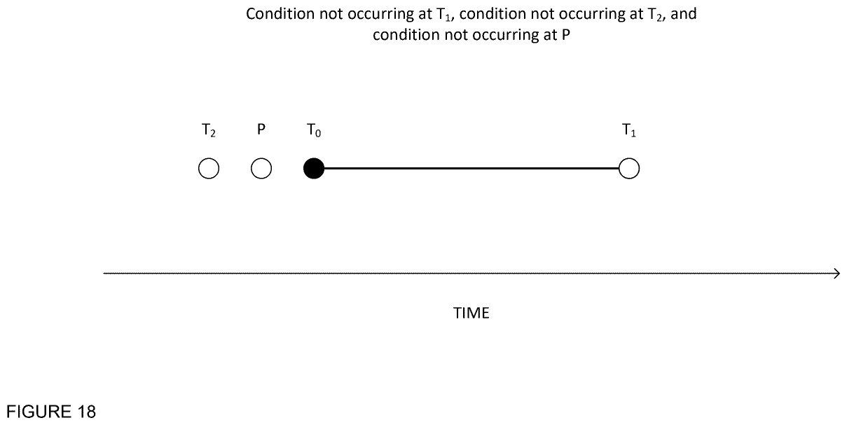

Turning to FIG. 18, in this example, T₂ is before T₀ and T₁, indicating that T₂ is earlier in time than T₁ and also earlier in time than T₀. In addition, a fourth payload (e.g., an “intervening” payload) is received (before the third payload was received) with a payload having a payload timestamp P between T₂ and T₀. In this example, one or more values of the second payload indicates that at T₁ the condition was not occurring, and the one or more values of the third payload indicates that at T₂ the condition was not occurring. The fourth payload P may also include one or more values indicating the condition was not occurring at P. In this example, the one or more servers computing devices 108 may ignore the third payload and take no additional action with the third payload.

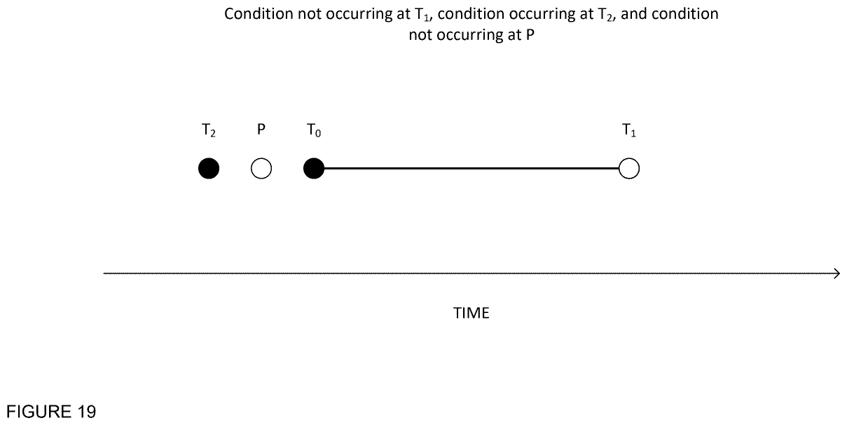

Turning to FIG. 19, in this example, T₂ is before T₀ and T₁, indicating that T₂ is earlier in time than T₁ and also earlier in time than T₀. In addition, a fourth payload (e.g., an “intervening” payload) is received (before the third payload was received) with a payload having a payload timestamp P between T₂ and T₀. In this example, one or more values of the second payload indicates that at T₁ the condition was not occurring, and the one or more values of the third payload indicates that at T₂ the condition was occurring. The fourth payload P may also include one or more values indicating the condition was not occurring at P.

In this example, the EventService Module 620 may add or create a new entry in the ConditionOccurrence Table 670 with a start time of T₂ and an end time of P.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload received at T₁ or maybe a downgraded alert that provides information indicating that additional information has been received for the condition and the prior alert is still relevant. In still other instances, if the EffectService Module 680 may determine whether an event for the condition already exists and if not, add an event for the EventRule to the Event Table 690. The EffectService Module 680 may also generate an alert.

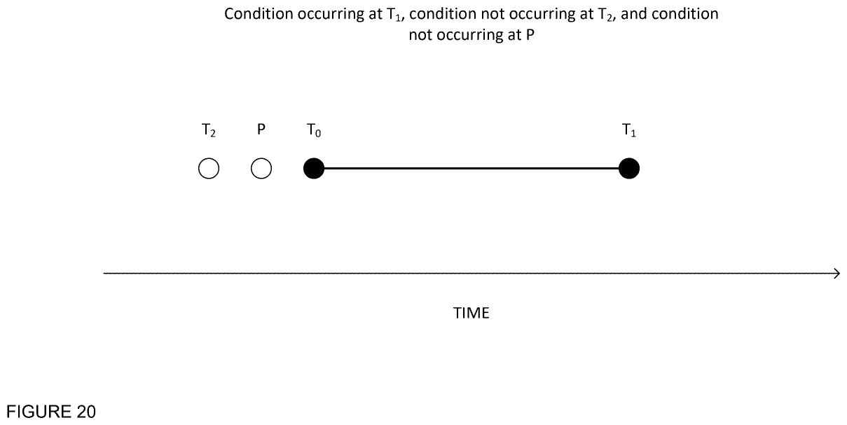

Turning to FIG. 20, in this example, T₂ is before T₀ and T₁, indicating that T₂ is earlier in time than T₁ and also earlier in time than T₀. In addition, a fourth payload (e.g., an “intervening” payload) is received (before the third payload was received) with a payload having a payload timestamp P between T₂ and T₀. In this example, one or more values of the second payload indicates that at T₁ the condition was occurring, and the one or more values of the third payload indicates that at T₂ the condition was not occurring. The fourth payload P may also include one or more values indicating the condition was not occurring at the timestamp of the fourth payload. In this example, the one or more servers computing devices 108 may ignore the third payload and take no additional action with the third payload.

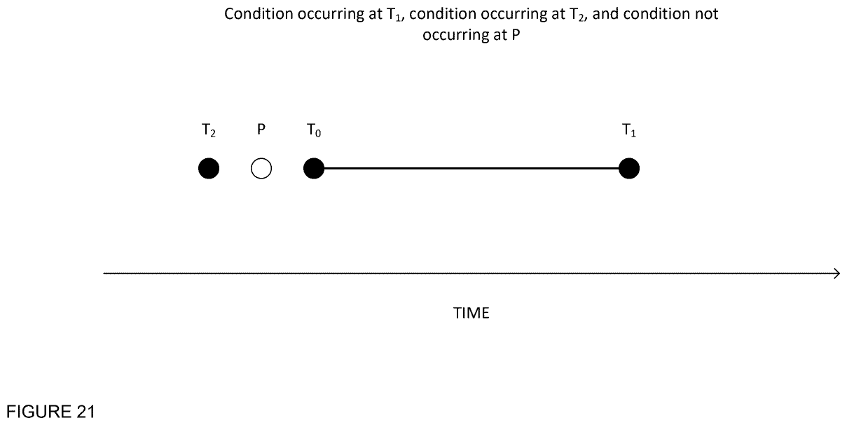

Turning to FIG. 21, in this example, T2 is before T0 and T1, indicating that T2 is earlier in time than T1 and also earlier in time than T0. In addition, a fourth payload (e.g., an “intervening” payload) is received (before the third payload was received) with a payload having a payload timestamp P. In this example, one or more values of the second payload indicates that at T1 the condition was occurring, and the one or more values of the third payload indicates that at T₂ the condition was not occurring. The fourth payload may also include one or more values indicating the condition was not occurring at P.

In this example, the one or more servers computing devices 108 may ignore the third payload and take no additional action with the third payload. Alternatively, the one or more servers computing devices 108 may take additional action. For example, the EventService Module 620 may create a new entry in the ConditionOccurrence Table 670 for the condition with a start time of T₂ and an end time of P.

In some instances, if the one or more values of the third payload results in an EventRule being met, the EventService Module 620 may send a message to the EffectService Module 680. The EffectService Module 680 may determine whether an event for the condition already exists and if so, take no action. In other instances, the EffectService Module 680 may determine whether an event for the condition already exists and if so, generate a second alert. This second alert may be the same as a prior alert (generated for the second payload received at T₁ or maybe a downgraded alert that provides information indicating that additional information has been received for the condition and the prior alert is still relevant. In still other instances, if the EffectService Module 680 may determine whether an event for the condition already exists and if not, add an event for the EventRule to the Event Table 690. The EffectService Module 680 may also generate an alert.

In some instances, the one or more server computing devices 108 may implement an additional software module, other than the EventService Module 620 or the EffectService Module 680. This additional software module may issue an event to the EventService Module 620. For example, if a tracked object crosses a geo-fence, the additional software module functioning as a geo-location service may trigger the EventService Module 620.

The features and methodology described herein may provide out of order condition tracking for tracked objects. The technology may reduce computational load for such tracking, compared to conventional methods. The technology is scalable and may support a diverse set of event types and scenarios.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method comprising:
receiving, by one or more processors, a payload that includes one or more values for a tracked object and a timestamp;
determining, by the one or more processors, that the payload is received out of order based on the timestamp;
comparing, by the one or more processors, the one or more value of the payload to one or more conditions;
based on the comparison and the determination that the payload was received out of order, determining, by the one or more processors, that an event associated with the one or more conditions has occurred; and
when the event is determined to have occurred, generating, by the one or more processors, an alert identifying the tracked object as well as a timestamp identifying when the one or more conditions were met.

2. The method of claim 1, further comprising updating an entry in a table of conditions based on the comparison and the determination that the payload was received out of order.

3. The method of claim 2, wherein updating the entry includes changing the timestamp of the entry to the timestamp of the payload.

4. The method of claim 1, further comprising adding a new entry in a table of conditions based on the comparison and the determination that the payload was received out of order.

5. The method of claim 1, further comprising:
receiving a second payload with a second value for the tracked object and a second timestamp; and
in response to the second payload, generating a second alert that indicates that the second value of the second payload has canceled the alert.

6. The method of claim 5, further comprising updating an entry in a table of conditions based on the second timestamp of the second payload.

7. The method of claim 6, wherein updating the entry includes changing the timestamp of the entry to the timestamp of the payload.

8. The method of claim 1, wherein the one or more values includes a sensed characteristic of the tracked object.

9. The method of claim 8, wherein the sensed characteristic includes temperature.

10. A system comprising one or more processors configured to:
receive a payload that includes one or more values for a tracked object and a timestamp;
determine that the payload is received out of order based on the timestamp;
compare the one or more value of the payload to one or more conditions;
based on the comparison and the determination that the payload was received out of order, determine that an event associated with the one or more conditions has occurred; and
when the event is determined to have occurred, generate an alert identifying the tracked object as well as a timestamp identifying when the one or more conditions were met.

11. The system of claim 10, wherein the one or more processors are further configured to update an entry in a table of conditions based on the comparison and the determination that the payload was received out of order.

12. The system of claim 11, wherein the one or more processors are further configured to update the entry by changing the timestamp of the entry to the timestamp of the payload.

13. The system of claim 10, wherein the one or more processors are further configured to add a new entry in a table of conditions based on the comparison and the determination that the payload was received out of order.

14. The system of claim 10, wherein the one or more processors are further configured to:
receive a second payload with a second value for the tracked object and a second timestamp; and
in response to the second payload, generate a second alert that indicates that the second value of the second payload has canceled the alert.

15. The system of claim 14, wherein the one or more processors are further configured to update an entry in a table of conditions based on the second timestamp of the second payload.

16. The system of claim 15, wherein the one or more processors are further configured to update the entry by changing the timestamp of the entry to the timestamp of the payload.

17. The system of claim 10, wherein the one or more values includes a sensed characteristic of the tracked object.

18. The system of claim 17, wherein the sensed characteristic includes temperature.

19. The system of claim 10, further comprising a reader device, wherein the payload is received from the reader device.

20. The system of claim 10, further comprising the tracked object.
